(19) United States
(12) Patent Application Publication
(10) Pub. No.: US 2002/0196854 A1
(43) Pub. Date: Dec. 26, 2002

(54) Fast video encoder using adaptive hierarchical video processing in a down-sampled domain

(76) Inventor: Jongil Kim, Austin, TX (US)

Correspondence Address: Patrick Stellitano, 2803 Inridge Dr., Austin, TX, 78745, US

(21) Appl. No.: 09/882,008

(22) Filed: Jun. 15, 2001

(51) Int. Cl. G06K 9/00; G06K 9/36; G06K 9/46; H04B 1/66; H04N 7/12; H04N 11/02; H04N 11/04

(52) U.S. Cl. 375/240.17; 382/107; 382/236; 375/240.24; 375/240.16; 375/240.27; 375/240.21

(57) ABSTRACT

A video encoding method and apparatus is presented that substantially reduces the computational requirements for motion processing by analyzing macro-blocks of down-sampled video frames to determine down-sample motion vectors from which motion vectors for the macro-blocks of the video frames are derived.

### SPECIFICATION

Commonly-assigned, co-pending United States patent application Ser. No. 9/609,610, filed Jul. 05, 2000, entitled “Video Compression: Methods and Systems for Fast and Efficient Compression of Digitally Sampled Video Data” is incorporated herein by reference.

### TECHNICAL FIELD OF THE INVENTION

The present invention relates to video encoding and motion estimation, and in particular relates to computationally efficient motion estimation while enabling substantial preservation of video quality.

### BACKGROUND OF THE INVENTION

In the field of video encoding and decoding, several standards have been developed, such as MPEG and H.263, for the processing of video information to enable interoperability between different video systems made by different manufacturers. Video processing according to the standards seeks to increase the number of video images that can be transmitted through a transmission channel per unit time and to increase the number of images that can be stored in a storage medium of a given capacity. To achieve increased efficiency a video encoder seeks to minimize the amount of data that must be transmitted to enable substantial reconstruction of the image when the transmitted video data is received at a decoder. This is accomplished by implementation of video compression, motion estimation and prediction processes.

A block diagram of a standard video encoder is shown in FIG. 1. Each video frame is divided into 16×16-pixel macro-blocks. Compression of video data is achieved by implementing a Discrete Cosine Transform (DCT) 100 upon each of four 8×8 pixel blocks of each macro-block. The transformed image is quantized 150 and the quantized transform components are “zig-zag” scanned 20 in an approximate descending order of the spatial frequency components of the DCT of the image. Variable Length Coding 25 is employed to use shorter sequences to encode more frequently occurring symbols and longer sequences to encode the less frequently occurring symbols to achieve a higher compression ratio. A buffer 30 is employed to enable adaptive adjustment of the quantization parameter to control the bit rate of the compressed video output by the encoder. The encoder also comprises inverse quantization 250 and Inverse Discrete Cosine Transformation 200 to decode a previous frame for use in a Motion Processor 300, comprising Motion Estimator 10 and Motion Compensation Predictor 15.

Motion processing further reduces the amount of data needed to enable substantial reconstruction of the image received by a decoder by estimating and predicting the motion in the video data. Motion Processor 300 performs analysis to find for each macro-block in a current frame a best matching macro-block of pixels in a decoded previous frame and also produces a motion vector indicating the displacement between the current macro-block and the best-match macro-block. When operating in this differential (inter-frame) mode, the encoder transmits the motion vector data and the difference between the best-match macro-block of the previous frame and the current macro-block. When operating in a non-differential (intra-frame) mode, the encoder transmits the encoded current macro-block.

It will be understood by persons of ordinary skill in the art that the previous frame referred to herein may occur before the current frame, in the case of forward prediction, or after the current frame, in the case of backward prediction, in the properly ordered sequence of frames forming the moving picture to be encoded.

Using data compression and motion processing, a video encoder can significantly reduce the amount of data needed to be transmitted to enable reconstruction of the image, and thereby increase the number of images that can be transmitted per unit time. However, operations performed by a video encoder are computationally intensive and require large processing power. Efficient encoding processes are therefore extremely important in the development of more efficient encoder implementations that conform to applicable standards. This is especially true for motion processing because this can consume the most substantial portion of the processing capacity required for encoder implementation.

For at least these reasons, there is a need for methods and apparatus for reducing the computational burden of performing encoder operations. In particular, there is a need to reduce the computational burden of performing motion processing in a video encoder.

### SUMMARY OF THE INVENTION

The present invention therefore provides methods and apparatus for motion processing that overcome limitations of the prior art and that substantially decrease the computational burden of encoding video data without sacrificing video quality.

The present invention achieves significant reduction in the computational burden of a video encoder by performing motion-processing operations in a down-sampled domain. According to the present invention a down-sampling process is applied to each of a succession of digitally sampled video frames and each video frame is thereby transformed to a corresponding down-sample frame. The down-sample frame contains far fewer pixels than the full-sample video frame from which it is derived; thereby presenting a frame that can be analyzed with far less computational burden. Nevertheless, the down-sampling process can preserve sufficient information for analysis in the resulting down-sample frames to enable reconstruction of the video image at a decoder so that video quality is not substantially sacrificed at the expense of computational efficiency.

By analyzing the down-sample frames, down-sample encoder parameters are produced that approximate corresponding encoder parameters obtainable from the full-sample video frames, but with far fewer computations. Encoder parameters computed in the down-sample domain are used to perform functions that enable determination of an efficient range of search for each motion vector to be found, classification of the motion of the video data being processed in order to further limit computations required to find motion vectors, and efficient determination of whether to operate in an inter-frame or intra-frame mode. Since the encoder parameters are computed in the down-sample domain, a substantial reduction in the computations required for obtaining sufficiently accurate encoder parameters can be achieved.

According to another aspect of the present invention, high-level motion estimation can be applied in the down-sample domain to produce a set of down-sample motion vectors that provide an approximation to the motion vectors of the full-sample video frame from which the down-sample frame is derived. The down-sample motion vectors obtained from high-level motion estimation are used to provide reference vectors that approximate the full-sample motion vectors corresponding to a video frame. A full-sample motion vector may be obtained from a reference vector by executing a low-level motion estimation process to find an optimal motion vector in the full-sample domain in the region of the reference vector. By using the down-sample motion vector to substantially narrow the range of search for the full-sample motion vector, further improvement in computational efficiency is achieved.

According to another aspect of the invention motion classifications of macro-blocks in the down sample domain are used in the full sample domain to further reduce the amount of computation required to find optimal full sample domain motion vectors. In particular, decisions whether to execute integer-pixel resolution motion estimation and half-pixel resolution motion estimation are made according to the level of motion indicated by suitable criteria applied to each down-sample macro-block.

Moreover, low-level motion estimation may be performed in a Normal mode or in a Fast mode to further enable an increase in the speed of motion estimation. In particular, when operating in the Fast low-level motion estimation mode, a reduced set of candidate motion vectors are selected to find the optimal full sample motion vector according to the spatial distribution of a chosen error function to be minimized.

The substantial reduction in the computational burden of performing motion estimation achieved by the methods disclosed herein allows for a substantial reduction in the computational resources that must be allocated to performing these functions, while enabling reconstruction of the image without substantial degradation in visual quality.

These and other aspects, features and advantages of the invention will be more readily understood with reference to the following description of embodiments of the invention and attached drawings. Persons of ordinary skill in the art will appreciate that various embodiments of the invention not specifically described herein fall within the scope of the invention as defined by the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a block diagram of a video encoder.

FIG. 2 shows a functional block diagram of an embodiment of the motion processing method of the present invention

FIG. 3 illustrates operation of a preferred embodiment of a down-sampling operation.

FIG. 4 illustrates operations of an embodiment of a scene analyzer and high-level motion estimator.

FIG. 5 illustrates four sub-blocks of a down-sampled macro-block.

FIG. 6 shows a functional block diagram of an embodiment of a low level motion estimator.

FIG. 7 illustrates candidate search positions for a full-sample motion vector with integer-pixel resolution.

FIG. 8 illustrates candidate search positions for a full-sample motion vector with half-pixel resolution.

### DETAILED DESCRIPTION OF THE PREFERRED EMBODIMENTS

The present invention provides a method and apparatus for fast video encoding using adaptive hierarchical video processing in a down sampled domain. According to the present invention, each video frame to be encoded by a video encoder is analyzed in a down-sample domain to increase the computational efficiency of frame analysis to more efficiently produce encoder parameters used by the encoder for motion processing.

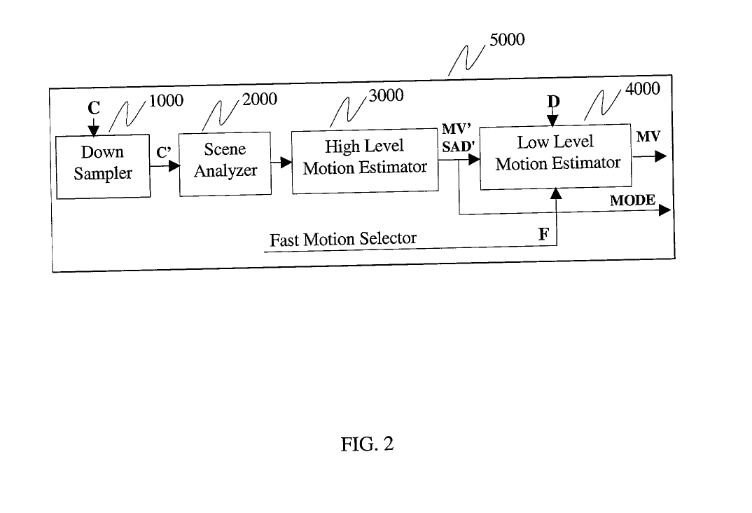

A functional block diagram of a preferred embodiment of the motion processing method of the present invention is shown in FIG. 2 as motion processor 5000, which is a subsystem of a video encoder. Motion processor 5000 comprises a down sampler 1000, a scene analyzer 2000, a high level motion estimator 3000, and a low level motion estimator 4000.

Down sampler 1000 implements a down-sampling process, performed on a frame by frame basis, to produce down-sample frames with substantially fewer pixels for subsequent analysis on a macro-block basis, and therefore enables substantial reduction of the computational burden of performing the operations implemented by scene analyzer 2000, high level motion estimator 3000 and low-level motion estimator 4000.

Scene analyzer 2000 performs computational analysis of each macro-block in the down-sample domain to produce encoder parameters that enable performance of the following functions with a high degree of computational efficiency: determination of a search range for high level motion estimation in the down sample domain; determination whether the encoder should operate in an inter- or intra- frame mode; and classification of the motion of each macro-block to determine if the down-sample motion vector for the macro-block should be the zero-vector, and to determine whether integer-pixel and half-pixel resolution motion estimation are performed by low level motion estimator 4000.

High-level motion estimator 3000 performs down-sample domain motion estimation in search ranges determined from computations performed by scene analyzer 2000 to produce down-sample motion vectors. The down-sample motion vector for a macro-block will be the zero-vector if scene analysis indicates a sufficiently low level of motion for the macro-block or will otherwise be the motion vector that provides the lowest value of a chosen down-sample error function.

Low-level motion estimator 4000 determines full-sample motion vectors by comparing the current full-sample frame with the previous decoded full-sample frame. A full sample motion vector for a full-sample macro-block is found in the vicinity of a reference vector derived from the down-sample motion vector of the corresponding down-sample macro-block. This substantially narrows the region of search for the optimal full sample motion vector for each macro-block and consequently results in a substantial reduction in the computational burden of determining full sample motion vectors for each video frame.

Low-level motion estimation comprises an integer-pixel resolution process and a half-pixel resolution process, which are executed or bypassed for each macro-block according to the motion classification of the macro-block determined in the down-sample domain. Thus, high-level (e.g, down-sample) motion estimation may be followed by: no further motion estimation, using the zero-vector as the full sample motion vector; or low-level integer-pixel resolution motion estimation, followed by low-level half-pixel resolution motion estimation; or low-level half-pixel resolution motion estimation only. Further reduction in computational burden and a more efficient allocation of computational resources within the encoder results from this selective application of integer-pixel and half-pixel resolution motion estimation according to the relative amount of motion indicated by scene analysis for each macro-block.

Further, low-level motion estimation may operate in a normal mode or fast mode. In Normal Mode, every candidate vector within a selectable search range is tested to determine the lowest value of the error function employed for the current estimation process. In Fast Mode only a subset of these candidate vectors within the search range is tested according to the spatial distribution of the error function employed in the preceding motion estimation process.

Thus, when low-level integer-pixel resolution estimation is performed in Fast Mode, the candidate vectors tested to determine the lowest value of the full-sample integer-pixel resolution error function depends upon the spatial distribution of the high-level error function employed in the down-sample domain. When low-level half-pixel resolution estimation is performed in Fast Mode directly following the execution of low-level integer-pixel motion estimation, the candidate vectors tested to determine the lowest value of the full-sample half-pixel resolution error function depends upon the spatial distribution of the full-sample integer-pixel resolution error function. Therefore, when operating in the Fast Mode, further reduction in computational burden can be achieved by reducing the set of candidate motion vectors employed to determine the lowest value of the integer-pixel and half-pixel error functions.

To the extent that the down-sample frame information approximates the information in the full-sample frame, the down-sample encoder parameters derived from the down-sample frame will approximate corresponding full sample encoder parameters derivable from the full-sample frame and only an insubstantial amount of information will be lost. Since the approximate encoder parameters are computed in the down-sample domain, a significant reduction in computation required to obtain sufficiently accurate encoder parameters is achieved.

Moreover, computing encoder parameters in the down-sample domain results in less computation to determine whether to operate the encoder in a differential mode and less computation to determine whether a motion vector may be set to zero. Further, by using the down-sample motion vectors to substantially narrow the ranges of search for the full-sample motion vectors, further computational reduction is achieved. Moreover, motion classifications of macro-blocks in the down-sample domain to selectively apply integer-pixel and half-pixel resolution motion estimation in the full-sample domain achieve further computational efficiency. Also, further computational savings can be achieved operating low-level motion estimation in a fast mode wherein fewer candidate motion vectors are tested to determine lowest values of the error functions employed.

A more detailed description of the operations of preferred embodiments of down sampler 1000, scene analyzer 2000, high level motion estimator 3000, and low level motion estimator 4000, is now provided.

Down sampler 1000 is applied to each of a succession of video frames, C, and each video frame is thereby transformed to a corresponding down-sample frame, C′. Down-sample frame, C, contains far fewer pixels than full-sample video frame, C′, from which it is derived, thereby presenting a frame that can be analyzed with far less computational burden. Nevertheless, the down-sampling process can preserve sufficient information in the resulting down-sample frames to enable reconstruction of the images so that video quality is not substantially sacrificed at the expense of computational efficiency.

In a preferred embodiment, down-sampler 1000 is implemented as a two-dimensional down-sampling process wherein down-sampling in one dimension reduces that dimension by a first scale factor, and down sampling in the other dimension reduces that dimension by a second scale factor. This can be accomplished by applying a two-dimensional filter to full-sample frame, C, comprising a first filter length and first set of filter weights applied to a first of the two dimensions of the frame and a second filter length and second set of filter weights applied to the second of the two dimensions of the frame.

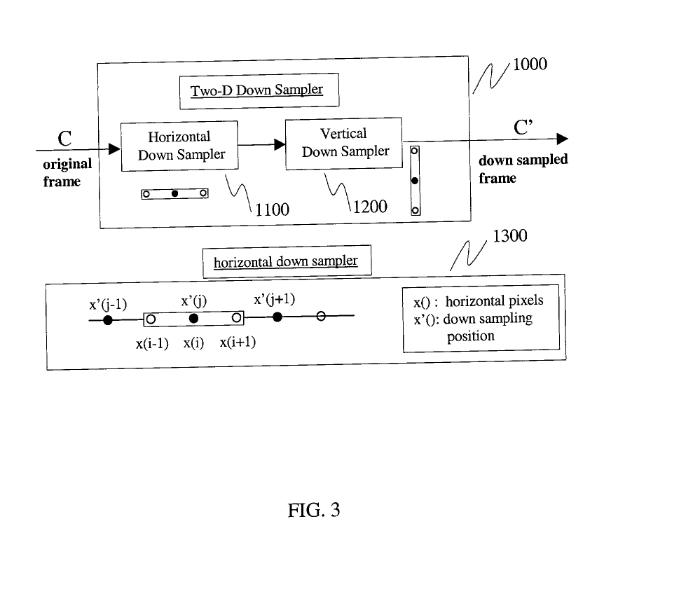

A more detailed illustration of the operation of a preferred embodiment of down sampler 1000 is shown in FIG. 3. As shown, full-sample video frame, C, is down-sampled horizontally, 1100, and then down sampled vertically, 1200. The horizontal sampling operation is illustrated in block 1300, which shows that the samples of the original frame, C, are filtered to form the down sampled frame, C′. This operation may be described according to the following equation:

$${x}^{′} ( j ) = {\sum }_{k = - N}^{N} h ( k ) \cdot x ( Sj + k )$$

$$0 \leq j \leq {J}_{max} = ( \frac{num\_of \_pixels}{S} - 1 )$$

where S is the horizontal down-sampling factor, and 2N+1 indicates the down-sampling filter length. The integer quantity, num_of_pixels, is the number of columns of pixels in the full-sample domain. For example, if the horizontal down-sampling factor equals two and the number of columns of pixels in the full sample domain is 128, then num_of_pixels=128, and Jₘₐₓ=63, resulting in a down-sample frame with half the number of columns as are in the full-sample frame. Suitable weights for a three-tap down-sample filter are h(−1)=0.25, h(0)=0.5, and h(1)=0.25.

The vertical down-sampling operation is similar to the horizontal down-sampling operation and is applied to the horizontal down-sample values. Thus, if the full-sample frame dimensions are (P,Q), the down-sample frame dimensions are (P/Sₓ, Q/S_{y}), where S_{y} is the horizontal down-sample factor for reducing the number of columns of the frame to be analyzed and S_{X} is the vertical down-sample factor for reducing the number of rows of the frame to be analyzed.

The result of the two-dimensional down-sampling operation performed by down-sampler 1000 is the down-sample frame, C′. The ratio of the number of pixels in the full-sample frame to the number of pixels in the down-sample frame is Sₓ×S_{y}. For example, using down-sampling factors of Sₓ=S_{y}=2 one obtains a down-sample frame that contains one-fourth as many pixels as the original frame. Thus, by down-sampling a frame, a much smaller matrix of pixel values is submitted for the complex processing operations to follow. This results in a substantial reduction in the computational burden of video encoding.

Clearly, if a down-sample factor is increased, the information in the down sample domain will decrease and the down-sample encoder parameters become less accurate approximations to their full-sample counterparts. Therefore, the down-sampling factors, S, must be chosen small enough to prevent significant loss of information. Similarly, increasing the filter length, 2N+1, also increases the amount of information lost in the down-sampling process. Therefore, the filter lengths for the horizontal filter and the vertical filter must also be chosen small enough to prevent significant loss of information.

In a preferred embodiment, each down-sample factor is chosen to equal 2. Similarly, although different filter lengths, 2N+1, and filter weights, h(k), could be employed for horizontal and vertical down-sampling, in a preferred embodiment, both the horizontal and vertical down-sample filters have 3 taps and correspondingly identical filter weights. These choices of down-sample factors, filter lengths, and weights result in a substantial reduction in computational burden while enabling reconstruction of the image with good visual quality by a decoder.

Alternatively, the filter characteristics, h(k) and N, as well as the scale factors, S, can be dynamically selected as a function of one or more measures of the accuracy of the down-sample representation and, or, as a function of one or more characteristics of the image. Further, separate controls could be applied to the respective horizontal and vertical values of S, N, and h(k) to provide independent dynamic adjustment of these parameters in the horizontal and vertical directions.

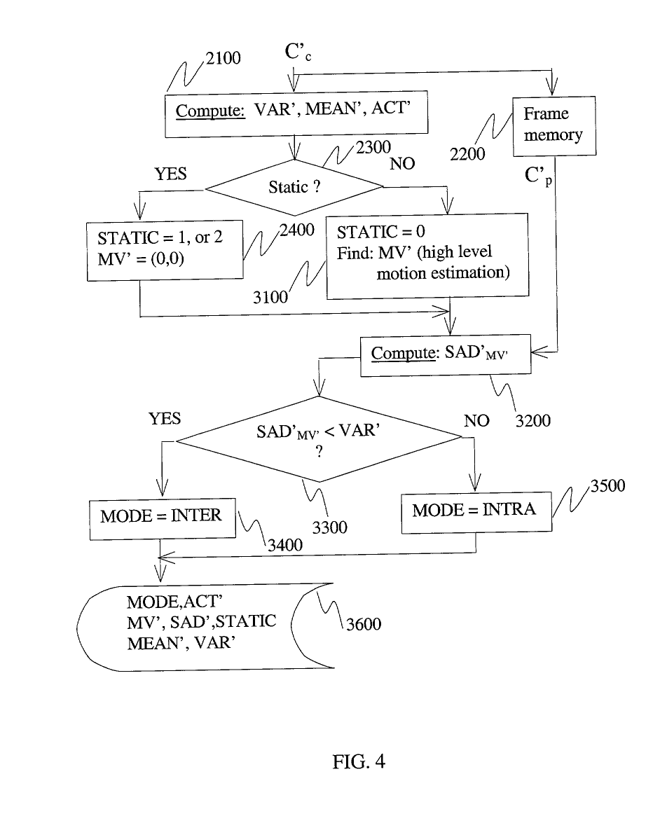

Scene analyzer 2000 operates upon the down-sample frames to produce encoder parameters that approximate the encoder parameters obtainable from the full-sample video frames. The operations of scene analyzer 2000 are applied to each macro-block, MB′, of the down sample frame, C′. A more detailed illustration of the operation of scene analyzer 2000 is shown in the flow chart of FIG. 4. Mean, MEAN′, modified variance, VAR′, and activity, ACT′, values are computed, at 2100, for the macro-blocks of the current down-sample frame, C′_{c}. The computations for producing these encoder parameters are performed according to the following equations:

$$\begin{matrix}{MEAN}^{′} ( x , y ) = \frac{1}{{M}^{′} \cdot {M}^{′}} {\sum }_{i = 0}^{{M}^{′} - 1} {\sum }_{j = 0}^{{M}^{′} - 1} {C}^{′} ( x {M}^{′} + i , y {M}^{′} + j ) \\ {VAR}^{′} ( x , y ) = \frac{1}{{M}^{′} \cdot {M}^{′}} {\sum }_{i = 0}^{{M}^{′} - 1} {\sum }_{j = 0}^{{M}^{′} - 1} \vert {C}^{′} ( x {M}^{′} + i , y {M}^{′} + j ) - {MEAN}^{′} ( x , y ) \vert \\ {ACT}^{′} ( x , y ) = 1 + min \{ {VAR}_{0}^{′} ( x , y ) , {VAR}_{1}^{′} ( x , y ) , {VAR}_{2}^{′} ( x , y ) , {VAR}_{3}^{′} ( x , y ) \} \\ {MEAN}_{k}^{′} ( x , y ) = \frac{1}{\frac{{M}^{′}}{2} \cdot \frac{{M}^{′}}{2}} {\sum }_{i = 0}^{\frac{{M}^{′}}{2} - 1} {\sum }_{j = 0}^{\frac{{M}^{′}}{2} - 1} {C}^{′} ( x \frac{{M}^{′}}{2} + i , y \frac{{M}^{′}}{2} + j ) \\ {VAR}_{k}^{′} ( x , y ) = \frac{1}{\frac{{M}^{′}}{2} \cdot \frac{{M}^{′}}{2}} {\sum }_{i = 0}^{\frac{{M}^{′}}{2} - 1} {\sum }_{j = 0}^{\frac{{M}^{′}}{2} - 1} \vert {C}_{k}^{′} ( x \frac{{M}^{′}}{2} + i , y \frac{{M}^{′}}{2} + j ) - \\ {MEAN}_{k}^{′} ( x , y ) \vert\end{matrix}$$

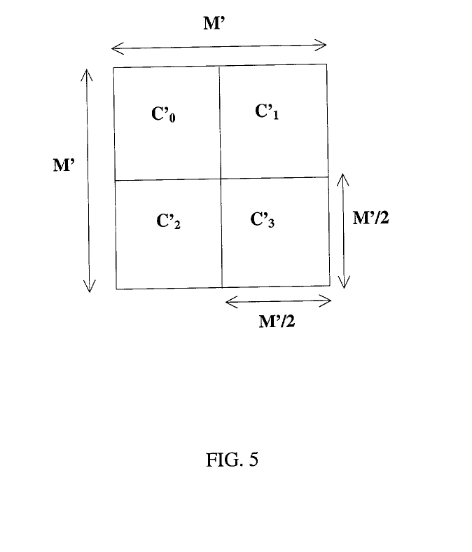

In these equations M′=M/S is the dimension of a down sample macro-block, M is the dimension of a full-sample macro-block (typically, 16), and x,y indicates the down-sample macro-block position in the frame. The subscript, k, indicates the one of four sub-blocks, C′ₖ, k=0,1,2,3, of a macro-block as shown in FIG. 5. For simplicity, in these equations the down-sampling factors are assumed to be the same in the horizontal and vertical directions, although different down-sampling factors could be employed, as described above. Similarly, it is assumed for clarity of exposition that the full sample macro-block dimensions are M×M although the present invention extends to macro-blocks of non-square dimensions, as will be recognized by persons of skill in the art given the disclosure herein. Thus, the present invention can be employed for, and increase the efficiency of, object-oriented video encoding, as well as block-matched encoding.

For example, with a down-sampling factor of S=2, and with M=16, the equations above reduce to:

$$\begin{matrix}{MEAN}^{′} = \frac{1}{8 \cdot 8} {\sum }_{i = 0}^{7} {\sum }_{j = 0}^{7} {C}^{′} ( i , j ) \\ {VAR}^{′} = \frac{1}{8 \cdot 8} {\sum }_{i = 0}^{7} {\sum }_{j = 0}^{7} \vert {C}^{′} ( i , j ) - {MEAN}^{′} \vert \\ {MEAN}_{k}^{′} = \frac{1}{4 \cdot 4} {\sum }_{i = 0}^{3} {\sum }_{j = 0}^{3} {C}_{k}^{′} ( i , j ) \\ {VAR}_{k}^{′} = \frac{1}{4 \cdot 4} {\sum }_{i = 0}^{3} {\sum }_{j = 0}^{3} \vert {C}_{k}^{′} ( i , j ) - {MEAN}_{k}^{′} \vert \\ {ACT}^{′} = 1 + min \{ {VAR}_{0}^{′} , {VAR}_{1}^{′} , {VAR}_{2}^{′} , {VAR}_{3}^{′} \}\end{matrix}$$

where the down-sample macro-block coordinates, x,y, have been suppressed in these equations for clarity.

The results of the above-described down-sample encoder parameter computations are used to determine an adaptive search range for determination of the down-sample motion vectors for each current macro-block in the down-sample domain. This is accomplished by comparing the mean, and modified variances of the current and previous macro-blocks to thresholds according to the following equations:

|MEAN′(c)−MEAN′(p)|=DEV_{MEAN′}≦TH_{MEAN′}

|VAR′(c)−VAR′(p)|=DEV_{VAR′}≦TH_{VAR′}

|MEAN′ₖ (c)−MEAN′ₖ (P)|=DEV_{MEAN′}≦TH_{MEAN′}

|VAR′ₖ (c)−VAR′ₖ (p)|=DEV_{VAR′}_{_{<TH}}_{VAR′}ₖ

where c and p denote the down sample macro-blocks of the current and previous frames, respectively.

To facilitate computational efficiency, a motion classification logic variable, STATIC, is employed according to the results of the four threshold comparisons given above. If the deviations, DEV, of all four of these equations are less than the respective thresholds, TH, then the current macro-block is defined as strictly static (STATIC=2), implying insignificant motion of the macro-block content between frames. In this event, the down-sample motion vector search range and down sample motion vector is set to zero, 2400. Also, if only the first two of the above equations are satisfied, then the current macro-block is defined as quasi-static (STATIC=1). In this event, the down-sample motion vector search range and down-sample motion vector is again set to zero, 2400. Otherwise, the current macro-block is defined as non-static (STATIC=0) and a non-zero search range is employed to find a down sample motion vector for the macro-block.

The foregoing macro-block motion classifications, strictly static, quasi-static, and non-static, are thus used to make zero-motion vector determinations in the down-sample domain. In addition, these macro-block motion classifications will also be advantageously employed to achieve substantial reduction in computations in the low-level motion estimation process 4000, as will be seen.

When STATIC=0, the adaptive down-sample search range limit, L′ₐ, for the down-sample motion vector for the current down-sample macro-block is determined according to following:

L′ₐ=L′·ƒ(DEV_{MEAN′}, DEV_{VAR′}, DEV_{MEAN′}, DEV_{VAR′}_{ₖ})

where, L=L/S, ƒ(x, y, . . . z) is a function that has incremental value proportional to its variables (x,y, . . . z), and L is an upper limit on the search range in the full-sample domain, which may typically be L=7, 15 or 31. The adaptive search range limit determination function, ƒ, is chosen to satisfy 1/L≦ƒ≦1, so that the adaptive search limit is itself limited to the range 1≦L′ₐ≦L′. Consequently, the adaptive search range can range from 0 to L′ₐ−1, the minimum search range being zero.

An example of a suitable adaptive search range limit determination function, ƒ, is:

$$f = \frac{1}{{L}^{′}} int [ \frac{{L}^{′} \sum ( DEV - TH )}{\sum DEV} ]$$

where the function, int[y], denotes the smallest integer greater than or equal to y. Thus, for example, if the sum of the four deviations, DEV, greatly exceed the sum of the four thresholds, TH, the expression within the square brackets approaches L′ and ƒ approaches 1. Conversely, to the extent that the sum of the deviations, DEV, is approximately equal to the sum of the thresholds, TH, the expression in the square brackets approaches zero and ƒ approaches 1/L′.

Persons of skill in the art will readily recognize other suitable adaptive search range limit determination functions, ƒ, that can be implemented to achieve the desired adaptive search range limit, given the disclosure herein. Moreover, it will be understood that different down-sample search range limits, L′ₐₓ and L′_{ay} can be determined for the vertical and horizontal directions respectively, given different scale factors, Sₓ and S_{y} and/or different adaptive search range limit determination functions,ƒₓ and ƒ_{y}.

The magnitudes of the deviations, DEV, are indicative of the change in the image that occurred from the previous frame to the current one. Large values of the deviations, DEV, imply that a great amount of motion has occurred in the image between frames. This implies that a larger field of search should be employed to find the motion vector that indicates the displacement from the current macro-block to the macro-block of pixels in the previous frame providing the best match to the current macro-block. For small deviations, the adaptive search range limit will be a small value, such as L′/2 or L′/4. The larger the deviations, the larger the adaptive search range limit will be, up to the maximum value of L′=L/S.

Note that the thresholds, TH, can all be set equal to the same value, e.g., 1, for natural scene sequences. Alternatively, the thresholds can be set to different values. Larger thresholds will result in less accurate scene analysis, but will result in fewer macro-blocks for which a motion vector search is performed. Thus, a tradeoff between computational time and visual quality can be achieved by the size of the thresholds used to determine the value of motion classification logic variable, STATIC, and the adaptive search range limits, L′ₐ. The thresholds can be pre-determined or set dynamically according to a measure of the video quality desired.

Note that the current down-sample frame, C′_{c}, is stored in frame memory, at 2200, and is therefore available for use as the previous down-sample frame, C′ₚ, in the next frame scene analysis performed by scene analyzer 2000. Also, stored for the next frame scene analysis are the current values of ACT′, MEAN′, and VAR′, which then become the ACT′, MEAN′, and VAR′ of the corresponding macro-block of the previous frame. The value of ACT′ is used, 3600, for rate control of the encoder so that if the activity in a macro-block becomes large, the rate of the encoder can be adjusted accordingly.

By performing scene analysis in the down-sample domain, the computational burden and memory requirements of performing scene analysis is substantially reduced in comparison to performing these computations in the full-sample domain. Also, as will be seen, a substantial reduction in the computational burden of determining the motion vector in the full-sample domain is achieved by using the down-sample motion vector to determine the approximate location of the full-sample motion vector.

It will be understood, that once scene analysis is performed, a search for a motion vector can be performed in the full-sample domain using the adaptive search range limits found from scene analysis, Lₐ=S×L′ₐ, without performing high-level motion estimation. That is, in a less preferred embodiment, high level motion estimation could be bypassed and low-level motion estimation could be performed within the adaptive limits defined by Lₐ=S×L′ₐ. This would result in some computational savings, but would not be as efficient as when high level motion estimation is performed within the down-sample adaptive search range to produce reference vectors used in the low-level motion estimation process.

In a preferred embodiment, when STATIC=1 or 2, the down-sample motion vector, MV′, for the current macro-block is set to zero, at 2400: that is, MV′=(0,0). If STATIC=0, then high-level motion estimator 3000 is employed to compute, MV′(x,y), the motion vector in the down-sample domain, 3100, corresponding to the current down-sample macro-block.

As previously noted, a motion vector is a spatial displacement vector that points from the current macro-block to a macro-block of pixels in the previous frame. The motion vector selected to correspond to the current macro-block is the one that points to the macro-block of pixels in the previous frame that most closely matches the current macro-block according to some chosen criteria. The macro-block of pixels in the previous frame that provides this “best match” to the current macro-block is referred to herein as the prediction block corresponding to the current macro-block. This is determined by finding the macro-block of pixel values in the previous frame that minimizes a suitable error function that is chosen to provide a measure of the difference between the current macro-block and the macro-block of pixels in the previous frame to which it is being compared.

Also as previously noted, persons of ordinary skill in the art will understand that the previous frame referred to herein may occur before the current frame, in the case of forward prediction, or after the current frame, in the case of backward prediction, in the properly ordered temporal sequence of frames forming the moving picture to be encoded. Thus, the present invention may be employed with frames type denoted in the art as I, P, and B frames.

Suitable error functions for determining the prediction block and its corresponding motion vector are known in the art. For example, the mean square error of the difference between the current block and a block of the previous frame may be chosen as the function to be minimized to find the “best” or “optimal” motion vector. As another example, the mean absolute difference between the current block and a block of the previous frame may be chosen as the error function to be minimized to find the “optimal” vector. Alternatively, other suitable error functions may be employed. By minimizing the chosen error function in the down-sample domain, rather than in the full-sample domain, a substantial reduction in computational burden and corresponding increase in computational speed is achieved.

It will be understood that the “best” or “optimal” motion vector, as these terms are used herein, simply refers to the motion vector that provides the “minimum” or “lowest” value of the chosen error function, and that the “minimum” value of the chosen error function, as the term is used herein, simply refers to the lowest value of the error function given by the process of minimizing the error function with integer-pixel or half-pixel resolution, as discussed herein.

In a preferred embodiment, high-level motion estimation 3000 employs a Sum of Absolute Differences, SAD′, 3200, computed with integer-pixel displacement, as the error function to be minimized in the down sample domain. This function is given by:

$${SAD}^{′} ( x , y ) = {\sum }_{i = 0}^{M - 1} {\sum }_{j = 0}^{M - 1} \vert {C}_{c}^{′} ( i , j ) - {C}_{p}^{′} ( i + x , j + y \vert + {B}^{′} ( x , y )$$

where, −(L′ₐ−1)≦x,y ≦(L′ₐ−1)

Here, C′_{c}(x,y) are the pixel values of the macro-block of the current down-sample frame, C′ₚ(i+x, j+y) are the pixel values of a displaced macro-block of pixel values in the previous down-sample frame, and L′ₐ are the adaptive down-sample search range limits described above.

The selected motion vector is the vector that minimizes the error function, SAD′(x,y), within the given search range limits, which, as previously noted, can be different for the vertical and horizontal directions.

The function B(x,y) is an offset value used to favor selection of a motion vector requiring the transmission of less data for its representation. Since variable length coding is used to transmit the motion vector data, it is desirable to select the motion vector data of smallest code length that minimizes the chosen error function. The offset function, B(x,y), may be computed according to the following equation:

$${B}^{′} ( x , y ) = [ code\_length ( x , y ) - code\_length ( 0 , 0 ) ] \frac{{M}^{′} \times {M}^{′}}{16}$$

where code_length(x,y) is the length of the binary code representing a motion vector, MV (x,y). With this formulation of the error function, SAD′(x,y), given above, of any two motion vectors corresponding to similarly minimum amounts of motion within the range of search, the motion vector requiring the shortest code length will be chosen. This results in a reduction of the amount of data required to transmit the motion vector for the macro-block.

Note that all of the values of B(x,y) depend only on the distance between pixels and can therefore be computed in advance and stored in memory, thereby saving computation time. The amount of memory required to store these offset values is (2L′−1)×(2L′−1).

Different search strategies known in the art may be employed for finding the motion vector for which SAD′ is a minimum within the search range defined by the adaptive down-sample search range limits, L′ₐ. The present invention provides the advantage of applying the search in the down-sample domain, allowing a more rapid and less computationally intensive determination of vectors from which the full-sample motion vectors may quickly be found.

Note that in the case of STATIC=1 or 2, a search for the minimum value of SAD′ is unnecessary because the motion vector is set to zero. Rather, when STATIC equals 1 or 2, only the value of SAD′(0,0) is computed, as it will be needed for the Inter/Intra mode decision to be described next. Thus, performing scene analysis in the down-sample domain results in an efficient classification of macro-block motion that further reduces computational burden.

Referring again to FIG. 4, an Inter/Intra mode decision is made by comparing the modified variance of the current macro-block to the minimum value of the high level motion estimation error function, SAD′, as determined above. If VAR′>min(SAD′), then MODE =INTER. Otherwise MODE=INTRA. If Inter-mode is selected, then low-level motion estimation is performed and the encoder sends differential macro block and motion vector data. If Intra-mode is selected, then no further motion estimation is performed, low-level motion estimator 4000 is bypassed, and the encoder transmits the encoded full-sample macro-block. The mode status, either INTER or INTRA, is also transmitted to instruct the decoder for proper reconstruction of the video information.

Thus, if the difference between the prediction block and the current block, as measured by the high-level motion estimation error function, SAD′, is less than the variance of the current macro-block data, it is deemed more efficient to transmit the difference macro-block and the motion vector data. In this case, a decoder reconstructs the macro-block by adding the difference macro-block to the prediction block determined from the motion vector. The present invention provides the advantage of executing the Inter/Intra mode determination process in the down-sample domain, thereby allowing a more rapid and less computationally intensive determination.

To the extent that the down-sample frame is a good approximation of the full-sample frame, results derived from computations using the down-sample frame should be a good approximation of the results that would be derived from computations using the full sample frame. Therefore, once the down-sample motion vector is obtained, it may be used to obtain a reference vector used by low level motion estimator 4000 for locating the full sample motion vector when MODE=INTER.

The reference vector, denoted R(x,y), is found by scaling the down sample motion vector, MV′(x,y), by the down-sampling factors, Sₓ and S_{y}; that is, R(x,y)=(Sₓ×x,S_{y}×y), where (x,y) are the coordinates of the down-sample motion vector. For example, in a preferred embodiment with scale factors of Sₓ−S_{y}=2, if the down-sample motion vector is (3,5), the reference vector used as an approximation to the full-sample motion vector is (6,10). When the down sample motion vector is the zero vector, (0,0), the reference vector is also the zero vector. By restricting the full-sample domain search to the vicinity of the reference vector, a substantial reduction in the computational burden of finding the full-sample motion vector is achieved.

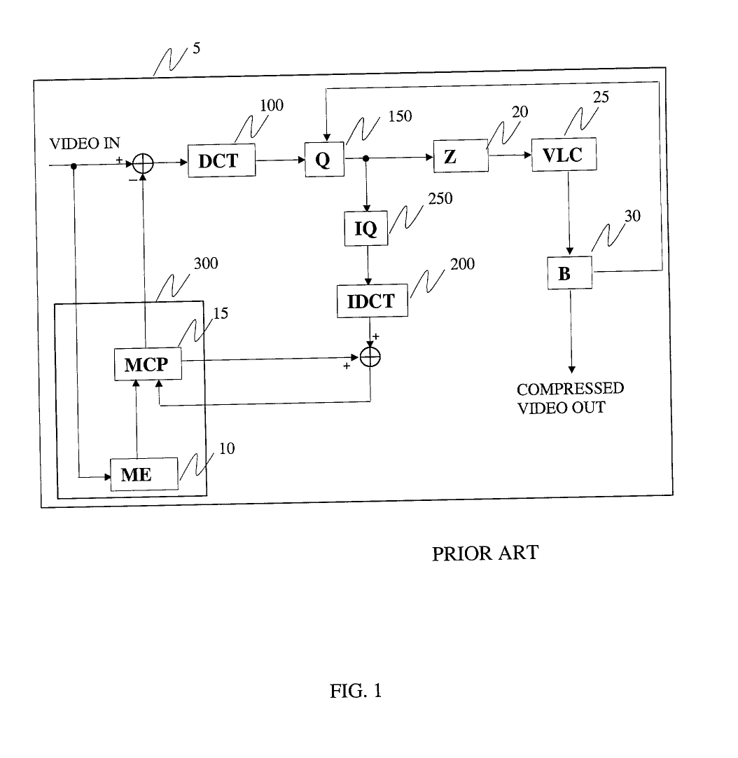

Low-level motion estimator 4000 uses the reference vector to determine the motion vector pointing from the macro-block of the current full-sample frame, C, to a macro-block constructed from the previous decoded full-sample frame, D, that minimizes a suitable error function computed in the full-sample domain. The previous decoded full sample frame, D, is obtained by inverse-discrete-cosine-transforming 200 the discrete-cosine-transformed 100 previous full sample frame as shown in FIG. 1.

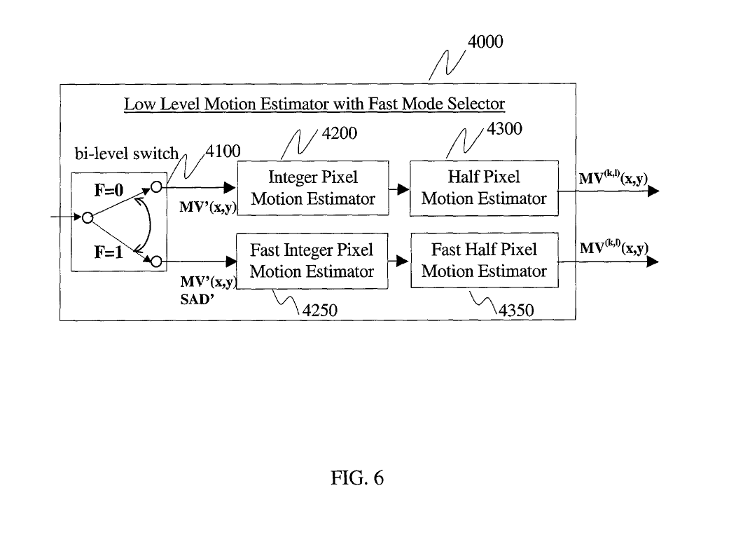

A block diagram of Low-Level Motion Estimator 4000 is shown in FIG. 6, where it is seen that low-level motion estimation may be performed in a Normal Mode or a Fast Mode according to whether Fast Mode Selector logic variable F is zero or one, as denoted by the bi-level switch 4100. The normal mode corresponding to F=0 is selected when higher visual quality is desired, whereas the fast mode corresponding to F=1 is selected when faster video encoding is preferred. In either mode, low-level motion estimation comprises an integer-pixel resolution motion estimation process, 4200 (normal mode) or 4250 (fast mode), to find an integer-pixel resolution motion vector, MV^{(0,0)}(x,y), that minimizes a suitable integer-pixel resolution error function, and a half-pixel resolution motion estimation process, 4300 (normal mode) or 4350 (fast mode), to find a half-pixel resolution motion vector, MV^{(k,l)}(x,y), that minimizes a suitable half-pixel resolution error function.

Whether integer-pixel resolution estimation and half-pixel resolution estimation is performed depends on the motion classification of the current macro-block as strictly static (STATIC=2), quasi-static (STATIC=1) or non-static (STATIC=0), as determined in the down-sample domain in scene analysis 2000. In a preferred embodiment, when the motion classification logic variable, STATIC, is equal to two, neither integer-pixel resolution estimation nor half-pixel resolution estimation is performed. When STATIC is equal to one, integer-pixel resolution motion estimation is bypassed and half-pixel motion estimation is performed. When STATIC is equal to zero, both integer-pixel and half-pixel resolution motion estimation are performed.

Thus, when the macro-block is deemed strictly static, no low-level motion estimation is performed: the full-sample motion vector is (0,0). When the macro-block is deemed quasi-static, integer-pixel resolution motion estimation is bypassed and half-pixel resolution motion estimation only is applied about the vicinity of the vector (0,0) to determine the half-pixel resolution motion vector, MV^{(k,l)}(0,0). When the macro-block is deemed non-static, integer-pixel resolution motion estimation is performed about the vicinity of the reference vector R(x,y), to determine an integer-pixel resolution motion vector, MV^{(0,0)}(x,y). Then half-pixel resolution motion estimation is performed in the vicinity of the integer-pixel resolution motion vector, MV^{(0,0)}(x,y), to find a half-pixel resolution motion vector, MV^{(k,l)}(x,y), This selective process advantageously employs the results of scene analyzer 2000 to limit the amount of computation performed in the full sample domain to determine an optimal full sample motion vector.

In a preferred embodiment, the integer-pixel resolution error function employed in the integer-pixel resolution motion estimation process, 4200 or 4250, is the sum of absolute differences, SAD(x,y), given by:

$$SAD ( x , y ) = {\sum }_{i = 0}^{M - 1} {\sum }_{j = 0}^{M - 1} \vert C ( i , j ) - D ( i + x , j + y ) \vert$$

where C is the current full-sample frame and D is the previous decoded full-sample frame. The range of the search coordinates, (x,y), for the full-sample integer-pixel resolution motion vector is limited about the reference vector, R(xᵣ,yᵣ), within the range:

xᵣ−(Lᵣₓ−1),yᵣ−(L_{ry}−1)≦x,y≦xᵣ+(Lᵣₓ−1), yᵣ+(L_{ry}−1)

where (xᵣ,yᵣ) are the coordinates of the reference vector in the full-sample domain, and (Lᵣₓ, L_{ry}) are the integer-pixel resolution search range limits within the range 1,1≦Lᵣₓ,L_{ry}≦Sₓ,S_{y}.

The values of (Lᵣₓ, L_{y}) are set according to the motion classification of the macro-block. When the motion classification logic variable, STATIC, is equal to one or two, the integer-pixel resolution search range limits, (Lᵣₓ, L_{y}) are set equal to one, and no integer-pixel resolution estimation is performed. When STATIC is equal to zero, Lᵣₓ, and L_{ry} are each set to an integer value greater than 1 up to (Sₓ, S_{y}), respectively, according to the number of candidate search positions desired, and integer-pixel resolution motion estimation is performed.

Preferably, both scale factors, Sₓ and S_{y}, are equal and the integer-pixel resolution search range limits are also equal: Lᵣₓ=L_{ry}=Lᵣ. When the motion classification logic variable, STATIC, is equal to one or two, the integer-pixel resolution search range limit, Lᵣ is set equal to one, and no integer-pixel resolution estimation is performed. When STATIC is equal to zero, Lᵣ is set to an integer value greater than 1 up to S, according to the number of candidate search positions desired, and integer-pixel resolution motion estimation is performed. For example, suppose S is equal to 3. When STATIC=0, Lᵣ can take on the values of 2, or 3. When Lᵣ is chosen to equal 2, there will be eight candidate search positions about the reference vector, R(x,y). When Lᵣ is chosen equal to 3, there will be 24 candidate search positions about the reference vector.

In a preferred embodiment S=2, so that the integer-pixel resolution search range limit can equal one or two. When the integer-pixel resolution search range limit, Lᵣ, is equal to one, the search coordinates, (x,y), will take on the values (xᵣ,Yᵣ) and no refining search will be performed. In this case the integer-pixel resolution motion vector is the zero-vector. When the integer-pixel resolution search range limit, Lᵣ, is equal to two, the range of search is:

Xᵣ−1,yᵣ−1≦x,y≦Xᵣ+1,yᵣ+1

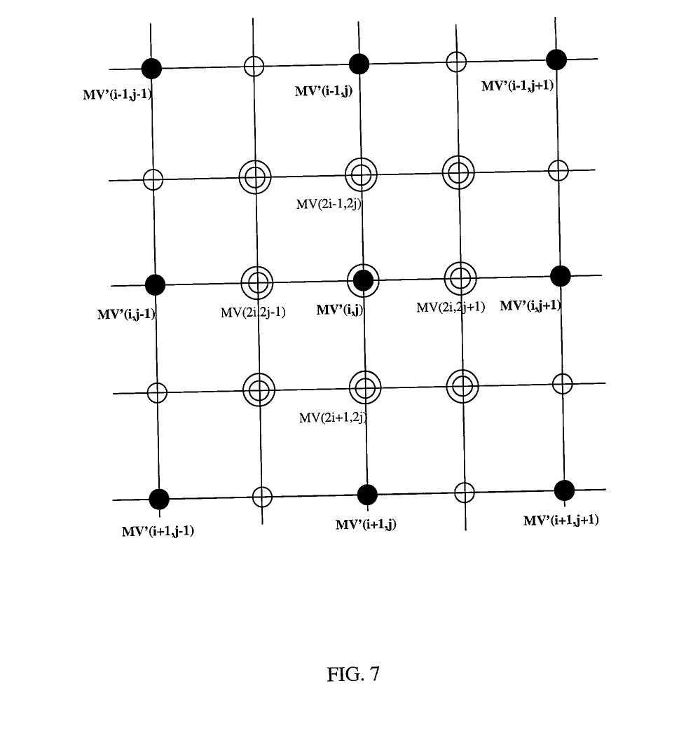

This is illustrated in FIG. 7, where the dark filled circle surrounded by a concentric circle shows the position of the down-sample motion vector, MV′(i, j), from which the reference vector is derived, and the concentric unfilled circles show the eight integer-pixel resolution candidate search positions in the full-sample domain, in terms of down-sample coordinates, about the reference vector that may be tested to minimize the error function, SAD(x,y), in an integer-pixel resolution mode. The result of integer-pixel resolution motion estimation is determination of the integer-pixel resolution motion vector, MV^{(0,0)}(x,y), which is the vector that produces the lowest value of SAD(x,y).

When STATIC equals zero or one, half-pixel resolution motion estimation is performed. Half-pixel resolution motion estimation process 4300 or 4350 searches for the half-pixel resolution motion vector in the region of the motion vector determined by the integer-pixel resolution motion estimation process, or alternatively, the zero-vector if integer-pixel resolution motion estimation is bypassed. Half-pixel resolution estimation uses interpolated data, D^{(k,l)}(i,j), derived from the previously decoded full sample frame, D(i,j). The half-pixel resolution search limit indices, (k,l), are used to index the pixel coordinates of the decoded previous full sample frame, D(ij), to obtain the interpolated pixel values, D^{(k,l)}(i,j), as follows:

D^{(k,l)}(i, j)=D(i,j)if|k|+|l|=0

D^{(k,l)}(i, j)={D(i,j)+D(i+k, j+l)}//2 if |k|+|l|=1

D^{(k,l)}(i,j)={D(i,j)+D(i,j+l)+D(i+k,j)+D(+k,j+l)}//4 if |k|+|l|=2

where, −1≦k, l ≦1, |x| is the absolute value operator and // is the integer rounding operator.

The half-pixel resolution motion vector, MV^{(k,l)}(x,y), is defined by the index pair, (k,l), that minimizes the half-pixel resolution error function, SAD^{(k,l)}(x,y), given by the following equation:

$${SAD}^{( k , l )} ( x , y ) = {\sum }_{i = 0}^{M - 1} {\sum }_{j = 0}^{M - 1} \vert C ( i , j ) - {D}^{( k , l )} ( i + x , j + y ) \vert$$

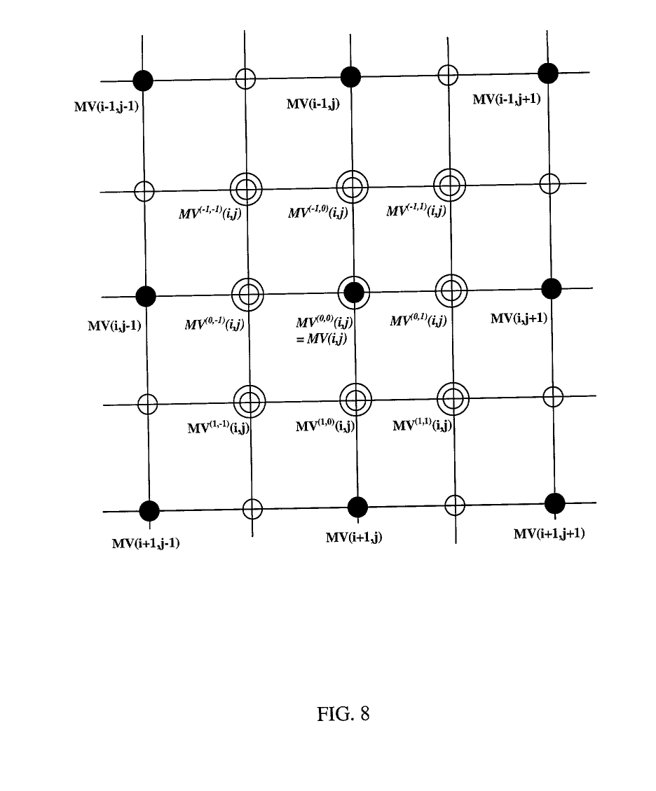

FIG. 8 illustrates the nine search positions that may be tested to minimize this error function in the half-pixel resolution motion estimation process. The dark filled circle surrounded by a concentric circle shows the position of the integer-pixel resolution motion vector, MV^{(0,0)}(x,y). This is the vector determined by the integer-pixel resolution motion estimation process that provides the lowest value of the integer-pixel resolution error function, or alternatively, the zero motion vector when integer-pixel resolution motion estimation is bypassed. The concentric unfilled circles show the eight half-pixel resolution candidate search positions about MV^{(0,0)}(x,y) in terms of full sample domain coordinates. The result of half-pixel resolution motion estimation is determination of the half-pixel resolution motion vector, MV^{(k,l)}(x,y), which is the vector that produces the lowest value of SAD^{(k,l)}(x,y).

The candidate search positions within the search ranges defined above for integer-pixel and half-pixel resolution motion estimation that are actually tested will depend on whether low-level motion estimation is performed in normal mode or fast mode as selected by bi-level switch 4100. For normal low-level integer-pixel resolution motion estimation all candidate search positions within the range defined by (Lᵣₓ, L_{y}) are tested 4200 to find the vector that provides the lowest value of the integer-pixel resolution error function. For fast low-level integer-pixel resolution motion estimation a subset of the integer-pixel resolution candidate search positions may be tested 4250 according to the spatial distribution of the high-level motion estimation error function.

Similarly, for normal low-level half-pixel resolution motion estimation all candidate search positions within the range defined by the half-pixel resolution search range indices, k,l, are tested 4300. For fast low-level half-pixel resolution motion estimation, a subset of the half-pixel resolution candidate search positions chosen according to the distribution of SAD(x,y) may be tested 4350, when fast integer-pixel resolution motion estimation is performed. When fast integer-pixel resolution motion estimation is bypassed, then all half-pixel resolution candidate search positions about the zero-vector will be tested, since STATIC=1 and no prior error function distribution is computed for the macro-block.

Thus, when low-level integer-pixel resolution estimation is performed in Fast mode, the candidate vectors tested to determine the lowest value of the full-sample integer-pixel resolution error function depends upon the spatial distribution of the high-level error function employed in the down-sample domain. When low-level half-pixel resolution estimation is performed in Fast mode directly following the execution of low-level integer-pixel motion estimation, the candidate vectors tested to determine the lowest value of the full-sample half-pixel resolution error function depends upon the spatial distribution of the full-sample integer-pixel resolution error function. When low-level half-pixel resolution estimation is performed in Fast mode directly following the execution of high-level motion estimation, —that is, when integer-pixel resolution motion estimation is bypassed—all half-pixel candidate vectors are tested to determine the lowest value of the full-sample half-pixel resolution error function.

In Fast mode, a subset of the integer-pixel resolution candidate search positions within the range defined by the integer-pixel resolution search limits, (Lᵣₓ, L_{ry}) may be selected for testing 4250 according to the spatial distribution of the high-level motion estimation error function. This may be done by analysis of the high-level motion estimation error function to determine in which direction, with respect to the reference vector, R(x,y), a lowest value of the integer-pixel resolution motion estimation error function is likely to be found.

Suppose down-sampling factors of S=2, a search range of Lᵣₓ=L_{ry}=Lᵣ=2, and that the lowest value of high level motion estimation error function, SAD′ (x,y), found in the down-sample computations corresponds to the down sample motion vector, MV′ (xₘ, yₘ). Then the eight down-sample vectors adjacent to MV′(xₘ, yₘ), in terms of integer-pixel down-sample coordinates, are:

MV′(Xₘ+i, Yₘ+j)

where, −1≦i, j ≦1. The values of the down-sample error function, SAD′ (x,y) , corresponding to these vectors, MV′, provide an indication of the shape of a continuous surface z′=SAD′(x,y) in the vicinity of the point Z′ₘ=SAD′ (Xₘ, yₘ), the SAD′ value corresponding to MV′(xₘ, yₘ). The approximate slope of this surface, Δz′ₘ=SAD′ (xₘ+i,yₘ+j)-SAD′(xₘ, yₘ), in a given direction provides an indication of the rate of change of the continuous surface, z′ (x,y), about the point z′ₘ in the given direction.

When the surface z′=SAD (x,y) is sufficiently smooth in the vicinity of the point z′ₘ, the direction in which the smallest rate of change occurs can be expected to be the direction in which the lowest value of the low-level integer-pixel motion estimation error function, SAD, is likely to be found when the integer-pixel resolution process is executed. Stated conversely, the integer-pixel resolution motion vector that provides the lowest value of SAD is least likely to be found in the direction of greatest rate of change in z′=SAD′ (x,y).

Thus, by simple analysis of the spatial distribution of the down sample error function, a subset of the low-level motion estimation integer-pixel search candidates can be selected to determine which of them provides the lowest value of the integer-pixel resolution error function. In some cases, the tested subset of candidate vectors may exclude the search position that would result in the lowest value of SAD if all the candidate search positions were tested. This can occur, for example, when the surface z′=SAD′ (x,y) is not smooth in the vicinity of the point z′ₘ In such cases, fast low-level motion estimation will be less than optimal in comparison to when operating in Normal mode, F=0. Nevertheless, by reducing the number of candidate vectors to be tested, further computational savings can be achieved.

A preferred method of determining the subset of integer-pixel resolution candidate search positions based on analysis of the down-sample error function distribution can be seen from the following examples.

### EXAMPLE 1

Consider the array of adjacent down-sample error function values computed in the high level motion estimation process.

SAD′₁₁SAD′₁₂SAD′₁₃

SAD′₂₁SAD′₂₂SAD′₂₃

SAD′₃₁SAD′₃₂SAD′₃₃

where SAD′_{xy}=SAD′₂₂ is found to be the lowest value of SAD′(x,y). Suppose that SAD′₁₃ is the next lowest value of SAD′(x,y) in the array. Then, in the fast low-level integer-pixel resolution motion estimation process, the integer-pixel resolution candidate motion vectors most likely to produce the lowest value of SAD are deemed to be the candidate vectors that produce the following subset of SAD values:

•SAD₁₂ SAD₁₃

•SAD₂₂ SAD₂₃

where the “•” symbol indicates the integer-pixel resolution search candidates that are eliminated from consideration. The subscript indices shown here for SAD_{xy} preserve the spatial directions indicated by the subscript indices given for the array of adjacent SAD′_{xy} values shown above.

Clearly, the next step could be to compute all four of the subset of SAD values to determine which is the lowest. However, it is more efficient simply to choose SAD₂₂ if the difference between SAD′₁₃ and SAD′₂₂ is not sufficiently small. That is, the larger the difference between these two values, the closer SAD′₂₂ is likely to be to the actual minimum of the error function SAD′(x,y). Thus, in a preferred embodiment the subset of SAD values will be computed only if the following condition is satisfied:

SAD′₁₃<αSAD′₂₂

where α is a constant chosen according to the speed and accuracy of fast motion estimation desired. Otherwise, the integer-pixel resolution motion vector is chosen to be the one that produces SAD₂₂.

### EXAMPLE 2

As another example, suppose again that SAD′₂₂ is the lowest value of SAD′_{XY} found in the down-sample domain, but suppose instead that SAD′₃₂ is the next lowest adjacent value of SAD (x,y). Then, in the fast integer-pixel resolution motion estimation process the subset of SAD values that are computed to determine the fast integer-pixel resolution motion vector are:

• • •

• SAD₂₂ •

• SAD₃₂ •

provided that the following condition is satisfied:

SAD′₃₂<αSAD′₂₂

Otherwise, the integer-pixel resolution motion vector is chosen to be the one that produces SAD₂₂.

The constant, α, affects the speed of fast low-level motion estimation and may be determined experimentally to give a desired result. In a preferred embodiment, α is chosen in the range 1.0 to 1.2. The larger the value of α, the slower the fast low-level motion estimation process will be, since the testing of full sample candidate motion vectors is more likely to occur.

A preferred method of determining the subset of half-pixel resolution candidate search positions to be tested may be determined from analysis of the low-level integer-pixel error function values computed in the fast integer-pixel resolution estimation process as shown from the following examples.

### EXAMPLE 3

Consider the array of adjacent integer-pixel resolution error function values discussed in the fast integer-pixel resolution motion estimation process of Example 1:

• SAD₁₂ SAD₁₃

• SAD₂₂ SAD₂₃

• • •

subject to the threshold condition:

SAD′₁₃<αSAD′₂₂

If the threshold condition was not satisfied then the chosen low-level integer-pixel resolution motion vector was MV₂₂^{(0,02)}. In this case, no half-pixel resolution motion estimation is performed, since it is deemed unlikely to contribute to the accuracy of the full sample motion vector determination sufficiently to justify the increased computations.

However, if the threshold condition was satisfied, then more conditions are considered to determine which of the subset is chosen. In this case, suppose that SAD_{xy}=SAD₂₂ is found to be the lowest value of the subset of SAD values. Suppose further that SAD₁₃ is the next lowest value of this subset. Then, in the fast low-level half-pixel resolution motion estimation process, the half-pixel resolution candidate motion vectors most likely to produce the lowest value of SAD^{(k,l)}(x,y) are deemed to be the candidate vectors that produce the following subset of SAD^{(k,l)} values:

• SAD₂₂^{(-1,0)} SAD₂₂^{(-1,1)}

• SAD₂₂^{(0,0)} SAD₂₂^{(0,1)}

• • •

where the “•” symbol indicates the half-pixel resolution search candidates that are eliminated from consideration. Once again, a threshold condition is applied as follows. If

SAD₁₃<αSAD₂₂,

then determine which of the subset is chosen as Example 1. If the following

SAD₁₂+SAD₁₃+SAD₂₃<3αSAD₂₂

is satisfied, MV₂₂^{(-1,1)} is determined as a half-pixel resolution motion vector, but if not, SAD₂₃<αSAD₂₂ is considered for MV₂₂^{(0,1)}. The last condition, when the foregoing conditions are not satisfied, is SAD₁₂<αSAD₂₂ for choosing MV₂₂^{(-1,0)}. Otherwise, SAD₂₂^{(0,0)} is deemed the lowest.

These examples illustrate a preferred method for determining subsets of the integer-pixel and half-pixel resolution search candidates when performing fast low-level motion estimation. In each case, the two lowest adjacent values of the error function computed in the preceding estimation process are determined. If the difference between these two values satisfies a threshold condition, then the subset of error function values to be computed in the current motion estimation process is selected according to the direction indicated by the two lowest error function values. In the integer-pixel case, the motion vector that produces the lowest value in this subset is the motion vector selected in the current estimation process, yet in the half-pixel case, the motion vector that satisfies other threshold conditions in the subset is the motion vector. If the threshold condition is not satisfied, the motion vector selected in the current estimation process is the vector corresponding to the lowest of the two values of the error function computed in the preceding estimation process.

Thus, the present invention provides a fast video encoder using adaptive hierarchical video processing in a down-sampled domain. By applying a down-sample process to each of a succession of video frames, each video frame is transformed to a corresponding down-sample frame. By analyzing the down-sample frames, encoder parameters are produced that approximate the encoder parameters corresponding to the video frames. Since the approximate encoder parameters are computed in the down-sample domain, a substantial reduction in the computation required to obtain sufficiently accurate encoder parameters can be achieved without significant image degradation.

Further, a set of down-sample motion vectors is efficiently determined by applying high-level motion estimation in the down-sample domain within adaptive search ranges determined by analysis of each macro-block. The down-sample motion vectors are scaled to provide a set of reference vectors that approximate the full-sample motion vectors corresponding to a video frame. A full-sample motion vector is estimated from a reference vector by conducting a search constructed in a region of the reference vector. By using the down-sample motion vector to substantially narrow the range of search for the full-sample motion vector, further improvement in computational efficiency is achieved.

Also, down-sample analysis of the down-sample frames results in motion classifications of each macro-block that are employed to determine the extent to which high-level motion estimation, low-level integer-pixel resolution motion estimation, and low-level half-pixel motion estimation are performed. This results in further computational efficiency.

In addition, low-level motion estimation may be operated in a fast mode to reduce the number of candidate search positions that are tested to determine the full-sample motion vector for each macro-block, thereby further reducing computational burden.

Further, reduction of computational burden and improved computational efficiency of a video encoder can be achieved by employing the methods disclosed herein in conjunction with the fast and efficient video compression methods that are the subject of commonly assigned, co-pending U.S. patent application Ser. No. 09/609,610, filed Jul. 05, 2000, entitled “Video Compression: Methods and Systems for Fast and Efficient Compression of Digitally Sampled Video Data”, which is incorporated herein by reference.

Although the present invention and its advantages have been described in detail, it should be understood that the present invention is not limited to the particular embodiments described in the specification. Persons of skill in the art will recognize that various changes, substitutions and alterations can be made to the embodiments of the invention described herein to achieve advantages or objects of the invention without departing from the spirit and scope of the invention as defined by the appended claims.

What is claimed is:

1. A video encoder, comprising:
a down sampler for transforming each of a succession of video frames to a corresponding down-sample frame containing fewer pixels than the corresponding video frame from which it is derived;
a scene analyzer for analyzing one or more macro-blocks of pixels of a down-sample frame to determine for each of the one or more macro-blocks an adaptive search range;
a high-level motion estimator for determining for each analyzed macro-block a down-sample motion vector within the adaptive search range derived from analysis of the macro-block performed by the scene analyzer;
a low-level motion estimator for deriving for each down-sample motion vector a full-sample motion vector within a search range derived from the down-sample motion vector.

2. The video encoder of claim 1, wherein the scene analyzer further comprises:
classification of each analyzed macro-block; wherein the classification determines whether the down-sample vector for the macro-block is deemed to be zero or is a vector that provides a lowest value of an error function among a set of vectors within the adaptive search range.

3. The video encoder of claim 2, wherein the classification of the macro-block further determines the resolution of search for the full-sample motion vector.

4. The video encoder of claim 1, wherein the scene analyzer further comprises:
classification of each analyzed macro-block; wherein the classification of the macro-block determines the resolution of search for the full-sample motion vector.

5. The video encoder of claim 4, wherein classification of the macro-block determines whether the low-level motion estimator is:
bypassed; or
operates in an integer-pixel resolution mode, followed by a half-pixel resolution mode; or operates in a half-pixel resolution mode only.

6. The video encoder of claim 1, wherein low-level motion estimation further comprises determining according to a distribution of error function values computed by the high-level motion estimator a set of candidate search vectors from which the full-sample motion vector may be determined within the search range derived from the down-sample motion vector.

7. The video encoder of claim 6, wherein the low level motion estimator:
is operable in an integer-pixel resolution mode wherein a set of search positions for determining an integer-pixel resolution motion vector within the search range derived from the down-sample motion vector is selected according to a distribution of error function values computed by the high-level motion estimator; and
is operable in a half-pixel resolution mode wherein a set of search positions for determining a half-pixel resolution motion vector is selected according to a distribution of error function values computed in the integer-pixel resolution mode.

8. The video encoder of claim 1, wherein the down sampler down-samples a video frame in each dimension of the frame by equal scale factors.

9. The video encoder of claim 1, wherein the scene analyzer further determines whether the encoder operates in an inter-frame mode or an intra-frame mode.

10. A video encoding method, comprising the steps of:
down-sampling each of a succession of video frames to produce a corresponding down-sample frame containing fewer pixels than the corresponding video frame from which it is derived;
analyzing one or more macro-blocks of pixels of a down-sample frame to determine an adaptive search range for each of the one or more macro-blocks;
determining a down-sample motion vector for each macro-block within the adaptive search range derived from analysis of the each macro-block of the down-sample frame; and
deriving for each down-sample motion vector a full-sample motion vector that provides a lowest value of an error function among a set of one or more candidate vectors within a search range derived from the down-sample motion vector.

11. The video encoding method of claim 10, wherein analysis of a macro-block of a down-sample frame further comprises the steps of:
classification of each macro-block of a down-sample frame; wherein a down-sample vector is deemed to be zero or is a vector that provides a lowest value of an error function among a set of vectors within the adaptive search range according to the classification of the macro-block.

12. The video encoding method of claim 10, wherein the resolution of the full-sample motion vector is determined according to a classification of the macro-block of the down-sample frame to which the full-sample motion vector corresponds.

13. The video encoding method of claim 12, wherein determination of a full-sample motion vector is performable in an integer-pixel resolution mode and a half-pixel resolution mode.

14. The video encoding method of claim 10, wherein a full-sample motion vector is determined from a set of candidate search positions derived from analysis of a distribution of error function values computed within the adaptive search range derived from analysis of the macro-block.

15. The video encoding method of claim 10, wherein determination of a full-sample motion vector is performable in an integer-pixel resolution mode and a half-pixel resolution mode and:
in the integer-pixel resolution mode, an integer-pixel resolution motion vector is determined from a set of candidate search positions derived from analysis of a distribution of error function values computed within the adaptive search range derived from analysis of the macro-block; and
in the half-pixel resolution mode, a half-pixel resolution motion vector is determined from a set of candidate search positions derived from analysis of a distribution of error function values computed from the set of candidate search positions determined in the integer-pixel resolution mode.

16. The video encoder of claim 10, wherein a frame is down-sampled in each dimension of the frame by equal scale factors.

17. The video encoder of claim 10, wherein analysis of a macro-block further determines whether the encoder operates in an inter-frame mode or an intra-frame mode for transmission of video data corresponding to the macro-block.

18. A method for motion processing in a digital video encoder, comprising the steps of:
deriving from each video frame of a succession of video frames of a moving picture a down-sample frame containing a reduced set of pixels representative of information in the video frame from which the down-sample frame is derived; the down-sample frame comprising one or more down-sample macro-blocks of pixels, each down-sample macro-block corresponding to a full sample macro-block of pixels in the video frame;
analyzing the one or more down-sample macro-blocks in each down-sample frame to determine for each analyzed down-sample macro-block a down-sample motion vector representative of motion of the down-sample macro-block between adjacent down-sample frames;
determining for each down-sample motion vector a full-sample motion vector representative of the motion of the corresponding full-sample macro-block between adjacent video frames.

19. The motion processing method of claim 18, wherein analysis of each down-sample macro-block further comprises the step of:
determining the down-sample motion vector that provides the lowest value of an error function within an adaptive search range determined by one or more measures of the extent to which the down-sample macro-block data deviates from the data of the identically positioned down-sample macro-block within a previously analyzed down-sample frame.

20. The video encoding method of claim 18, wherein determination of the full sample motion vector further comprises the step of:
conducting a search for the full sample motion vector that minimizes an error function within a search range conducted in the vicinity of a reference vector derived from the down-sample motion vector.
